(19) United States
(12) Patent Application Publication
(10) Pub. No.: US 2026/0125097 A1
(43) Pub. Date: May 7, 2026

(54) STROLLER WITH ILLUMINATION SOURCE

(71) Applicant: Munchkin, Inc., Van Nuys, CA (US)

(72) Inventors: PIETRO CAPRA, Tarzana, CA (US); Michael LAUDI, Los Angeles, CA (US); Jonathan Gutierrez, Westlake Village, CA (US)

(21) Appl. No.: 18/934,971

(22) Filed: Nov. 1, 2024

Related U.S. Application Data
(60) Provisional application No. 63/547,256, filed on Nov. 3, 2023.

(51) Int. Cl. B62B 9/00; B62B 7/10; B62B 9/20; F21V 23/00; F21V 23/04

(52) U.S. Cl. CPC B62B 9/005; B62B 7/10; B62B 9/20; F21V 23/003; F21V 23/0435

(57) ABSTRACT

A stroller having an illumination source integrated into a frame. A input power source button is integrated into a handle of the frame to turn the illumination source on/off. The frame has a plurality of legs that extend from a lower portion of the frame and a plurality of wheels are attached to the legs. A seat is supported by the frame for a passenger. The illumination source is incorporated within a body of the frame to illuminate an area in, or around the stroller.

### CROSS REFERENCE TO RELATED APPLICATION

This Patent Application claims priority to U.S. Provisional Patent Application Ser. No. 63/547,256, filed Nov. 3, 2023, the content of which is hereby incorporated by reference herein in its entirety into this disclosure.

### TECHNICAL FIELD

The subject disclosure relates to a stroller and particularly to a stroller having an embedded illumination source within its frame that provides safety by illuminating low-lit environments.

### BACKGROUND

Strollers are a convenient method for transporting a child. Typically, strollers come in varying configurations to be used in numerous environments while maintaining the safety of the child when the stroller is in use. However, the problem with conventional strollers is that they are restricted to well-lit environments. Use of a conventional stroller in a low-lit environment becomes a hazard for the user as visibility can be dismal, creating a plethora of potential safety concerns for the passenger and the caretaker pushing the stroller over dark and uneven surfaces. Although various solutions have been proposed, none have effectively solved this dangerous problem.

### SUMMARY

The following presents a simplified summary of the subject disclosure to provide a basic understanding of some aspects thereof. This summary is not an extensive overview of the various embodiments of the subject disclosure. It is intended to neither identify key or critical elements of the subject disclosure nor delineate any scope thereof. The sole purpose of the subject summary is to present some concepts in a simplified form as a prelude to the more detailed description that is presented hereinafter.

One or more embodiments of the subject disclosure provides a stroller having an illumination source integrated into a frame construction. The frame construction is defined by a plurality of frame members. The frame members have a pair of upper frame members that are pivotally attached to a pair of midframe members. The midframe members are pivotally attached to a pair of lower frame members. Each pair of the frame members are respectively connected by a plurality of crossbar supports disposed between each frame members. Attached to the upper frame member is a handle. Integrated into the handle is a power button to turn the illumination source on/off. Attached to the distal ends of the lower frame members is a wheel. Integrated to the lower frame members above the wheel is the illumination source. A seat is removably secured to upper frame members and midframe members. A supportive seat base is fastened to a pair of seat support rails that are securely fastening the midframe members. Further, incorporated into the seat is a safety restraint mechanism.

### BRIEF DESCRIPTION OF DRAWINGS

FIG. 1 is a front perspective view of a stroller having an illumination source, according to an exemplary embodiment of the present subject disclosure.

FIG. 2 is a front perspective view of a stroller having an illumination source with a seat removed.

FIG. 3A is an exploded partial front perspective view of the stroller with an extending telescoping tubes.

FIG. 3B is an exploded partial front perspective view of the stroller with a retracting telescoping tubes.

FIG. 4A is an exploded rear perspective view of a rear wheel.

FIG. 4B is an exploded front perspective view of a front wheel.

FIG. 5 is a front view of the stroller having an illumination source.

FIG. 6 is a rear of the stroller.

FIG. 7 is a rear perspective view of the stroller showing an illumination source directing a source of light rearward adjacent to the stroller.

FIG. 8 is a rear perspective view of the stroller with the seat in a reclined position.

FIG. 9 is a left side view of the stroller with a canopy retracted showing an illumination source directing a source of light sideways along the stroller.

FIG. 10 is a left side view of the stroller with the canopy fully extended.

FIG. 11 is an exploded left side of the stroller with canopy being retracted.

FIG. 12 if a top view of the stroller with the canopy fully retracted.

FIG. 13 is an exploded left side of the stroller with canopy being extended.

FIG. 14 is an exploded left side of the stroller with canopy being fully extended.

FIG. 15 if a top view of the stroller with the canopy fully extended.

FIG. 16 is an exploded rear perspective view of the stroller with a power button being pressed.

FIG. 17 is a partial exploded front perspective view of the stroller of a power button compartment.

FIG. 18 is a partial exploded front view of the stroller of the power button compartment.

FIG. 19 is a partial exploded front perspective view of the stroller with the illumination source turned on.

FIG. 20 is a partial exploded bottom view of the stroller with a lower face of lower housing being removed.

FIG. 21 is a partial exploded front perspective view of the stroller with the lower face plate being removed.

FIG. 22 is a front perspective view of the stroller showing an exemplary internal wiring pattern.

FIG. 23 is an electronic schematic diagram of an electronic system of the stroller and features.

FIG. 24 is a left side view of the stroller being folded.

FIG. 25 is a left side view of the stroller being folded into a first folded configuration.

FIG. 26 is a left side view of the stroller being folded into a second folded configuration.

FIG. 27 is front view of the stroller in a folded configuration with the lower frame member being folded inwardly.

FIG. 28 is front view of the stroller in a folded configuration engaging a lock.

FIG. 29 is a rear perspective view of a stroller, according to an exemplary embodiment of the present subject disclosure.

FIG. 30 is a back view of the stroller.

FIG. 31 is a front view of the stroller in a compact folded configuration.

FIG. 32 is a top view of the stroller in a compact folded configuration.

### DETAILED DESCRIPTION

The subject disclosure is described with reference to the drawings, wherein like reference numerals are used to refer to like elements throughout. In the following description, for purposes of explanation, numerous specific details are set forth to provide a thorough understanding of the present disclosure. It may be evident, however, that the present disclosure may be practiced without these specific details.

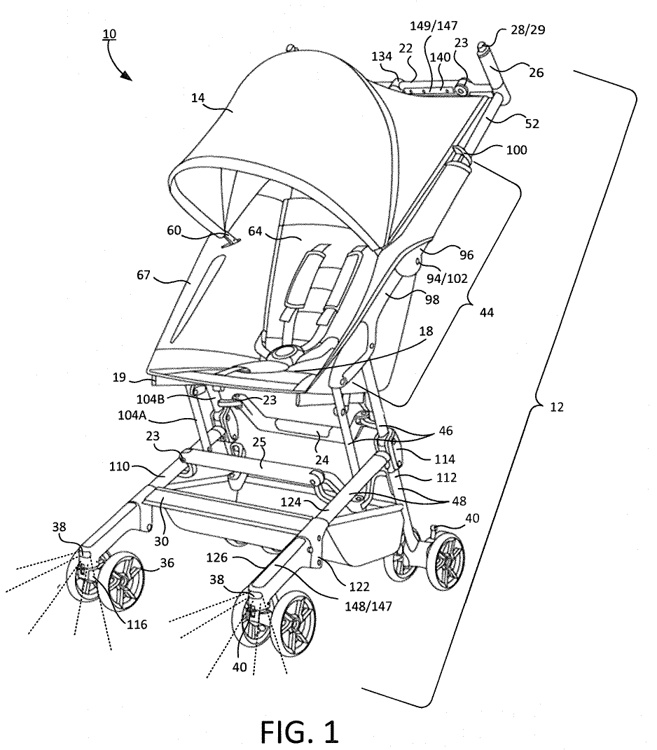

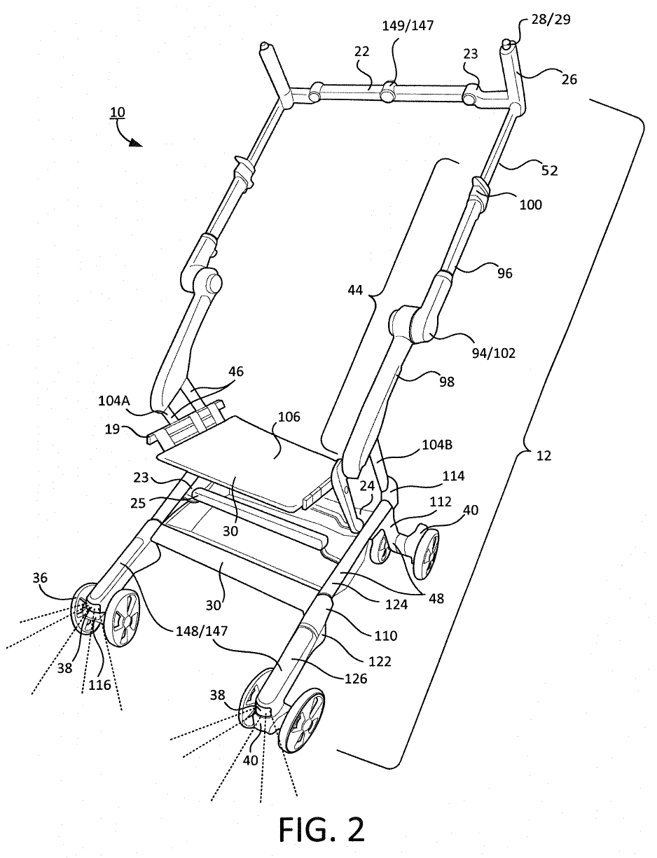

FIGS. 1-2 illustrate a stroller 10 having an illumination source 38 integrated into a frame 12 construction. Particularly, the illumination source 38 is a part of an exemplary stroller illumination control system 147 that includes a power control unit 149 in communication with an electronic lighting unit 148. The illumination source 38 is embedded within the electronic lighting unit 148 and is controlled by the power control unit 149, all of which are embedded within various portions of the frame 12 of the stroller 10. The present exemplary embodiment of the stroller 10 is, but not limited to, a compact and foldable construction.

The frame 12 construction is defined by a pair of upper frame members 44 that are pivotally attached to a pair of midframe members 46. The midframe members 46 are pivotally attached to a pair of lower frame members 48. The frame 12 is supported by an upper crossbar support 22, a mid-crossbar support 24 and a lower crossbar support 25. The upper crossbar support 22 is positioned between the upper frame members 44. The mid-crossbar support 24 is positioned between the midframe members 46. The lower crossbar support 25 is positioned between the lower frame members 48. The upper crossbar support 22, the mid-crossbar support 24 and the lower crossbar support 25 may have pivot joints 23 disposed therein respectively. For example, the pivot joints 23 may be located at either end of the upper crossbar support 22, the mid-crossbar support 24 and the lower crossbar support 25 to permit a folded and unfolded configuration. It is to be understood that the upper crossbar support 22, the mid-crossbar support 24 and the lower crossbar support 25 may have one or more pivot joints 23 configured to permit varying folding orientations. For example, as specifically show in FIG. 1, the upper crossbar support 22, the mid-crossbar support 24 and the lower crossbar support 25 may fold inwardly with one pivot joints 23 located in the center of each the upper crossbar support 22, the mid-crossbar support 24 and the lower crossbar support 25 respectively. It is to be understood that the upper crossbar support 22, the mid-crossbar support 24 and the lower crossbar support 25 may be dispersed throughout the frame 12 in any suitable manner capable of stabilizing the frame 12 of the present subject disclosure.

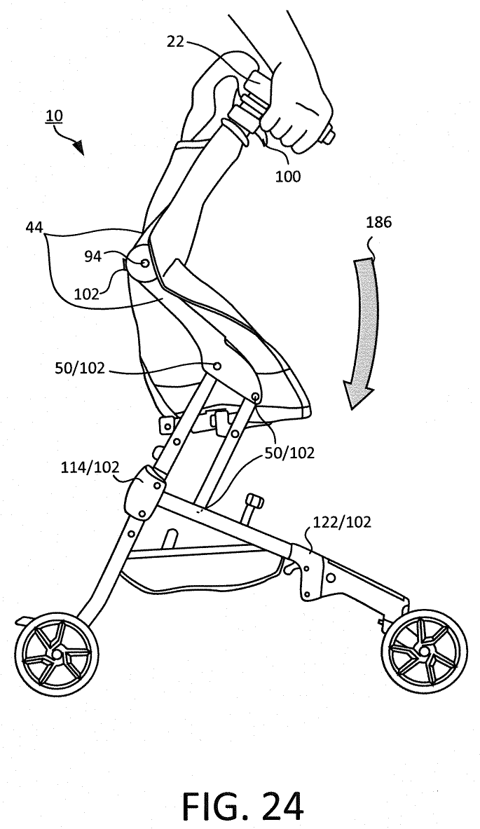

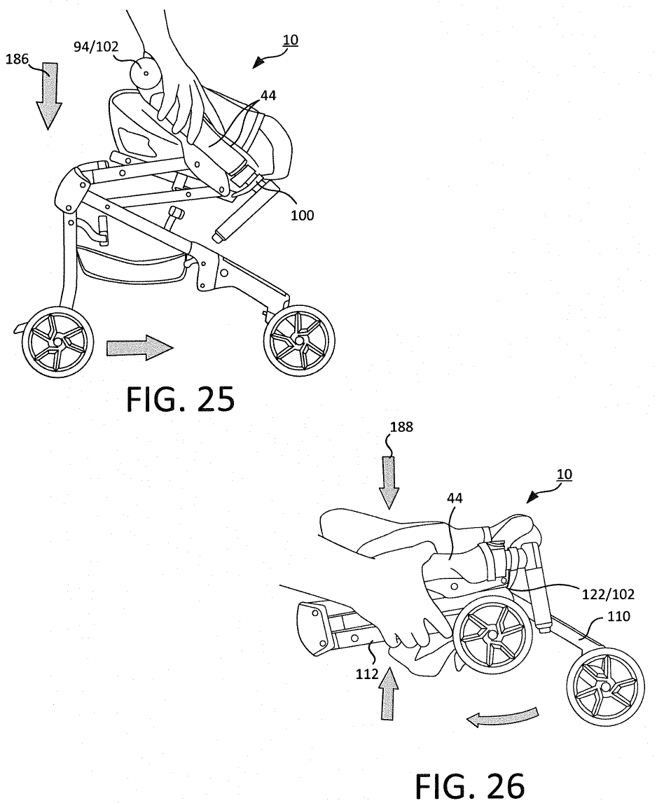

The upper frame members 44 may have two sections, an upper section 96 and a lower section 98 that are pivotally connected by a member joint 94. The member joint 94 is configured pivotally fold the upper section 96 atop the lower section 96 when folding the stroller 10 as will be discussed later in this subject disclosure. The member joint 94 further contains an internal joint lock 102 that is engaged/disengaged by a folding actuator 100. The folding actuator 100 is located at the distal end of the member joint 96. The folding actuator 100 may be, but is not limited to: a trigger, button, latch mechanism or any suitable actuating mechanism that can engaging/disengage the member joint 94 and internal joint lock 102. The internal joint lock 102 permits the upper frame members 44 to be in a fixed upright position in one configuration. In another configuration the internal member joint lock 102 permits the frame members 44 to be in a folded position, as shown in FIGS. 24-25.

Referring back to FIGS. 1-2, attached within each of the upper frame members 44 are telescoping tubes 52 attached to a handle 26. The handle 26 extends cylindrically upward from the distal end of the telescoping tubes 52 disposed within the upper frame members 44. The benefit of having the handle 26 extend cylindrically upward is to provide a user with comfortable pronated handgrip orientation. For example, a user's hand orientation may be more comfortable in a pronated orientation over a supinated orientation. It is to be understood that the handle 26 may be rotated inward or outward to provide a user with alternative handgrip orientations. Further, in alternative embodiments the handle 26 may be pivotally connected to the telescoping tubes 52 to allow the user to customize the handle 26 orientation to provide a customized handgrip orientation.

Integrated into the handle 26 is a handle extension actuator 28. The handle extension actuator 28 engages and disengages a handle extension locking mechanism 29. The handle extension actuator 28 may be, but is not limited to a: button, switch or any suitable method to engage and disengage handle extension locking mechanism 29. Telescoping tubes 52 slide within the upper frame members 44 to permit the extension of the handle 26. The telescoping tubes 52 have the handle extension locking mechanism 29 integrated within to securely lock the telescoping tubes 52 into place. The handle extension locking mechanism 29 may be but is not limited to: a lock and pin, magnetic lock or any suitable locking mechanism capable of restricting/permitting the movement of the telescoping tubes 52 and actuated by the handle extension actuator 28 as described in the present subject disclosure.

The midframe members 46 are made up of two extending rods 104A and 104B. The extending rods 104A and 104B are pivotally secured to the upper frame members 44 at one end. At a second end, the midframe members 46 are pivotally connected to the lower frame members 48. Attached to the midframe members 46 is a seat support rail 19.

The seat support rail 19 is configured to receive a seat support 16 that is disposed between the midframe members 46. The seat support 16 further has a substantially flat member 106 (not shown) integrated within the seat support 16. The substantially flat member 106 is rigid providing a complementary support for a child sitting within the seat. The seat support 16 is to provide an upward supporting force when the seat 18 is secured over the seat support 16. The material characteristics of the substantially flat member 106 prevents deformation. A material such as, but not limited to: plastic, metal, or any suitable material that substantially resists deformation and is capable of providing the flexible supporting needs as described by the subject disclosure. The substantially flat member 106 may be sewn into an exterior fabric or any other suitable means to fasten the seat support 16 to the seat support rail 19. The seat support 16 may be fastened to the seat support rail 19 through many different fastening methods such as but not limited to: sewing straps around the seat support rails 19, button clasp fixed to the seat support 16 and mating clasp on the seat support rails 19, a nail screwed through the fabric of the seat support 16 and into the seat support rails 19 or any other suitable fastening method capable of securing the seat support 16 to the seat support rails 19.

The benefits of having the seat support 16 is that the seat 18 may be made of a fabric material reducing the overall weight of the stroller 10. It is to be understood that the stroller 10 may also have a rigid seat 18 with it's own internal structure that connects directly to the frame 12.

The lower frame members 48 are made up of two segments, a front segment 110 and a rear segment 112. The rear segment 112 is pivotally attached and is colinear to one of the extending rods 104B. A connecting joint 114 is located at a midpoint between the rear segment 112 and the extending rod 104B. The front segment 110 then extends approximately perpendicularly outward from the connecting joint 114. The front segment 110 is pivotally connected at the midpoint by a second connecting joint 122.

The second connecting joint 122 defines a connecting point for an upper front segment 124 and a lower front segment 126. The connecting joint 114 permits the lower front segment 126 to fold inward towards the rear segment 112. Further the upper front segment 124 is pivotally connected to the extending rod 104A.

Located at the distal ends of the lower frame members 48 is a wheel 36. The wheel 36 is connected to an axal 116 to permit rotational movement of the wheel 36. The wheel 36 may be but is not limited to: a single wheel attached to a single wheel, dual wheels attached to a single axle 117 or any suitable combination of wheel 36 and axle 117 capable of permitting rotational movement of the wheel 36. The wheel 36 may be pivotally attached or fixed to the front segments 110 and/or the rear segments 112.

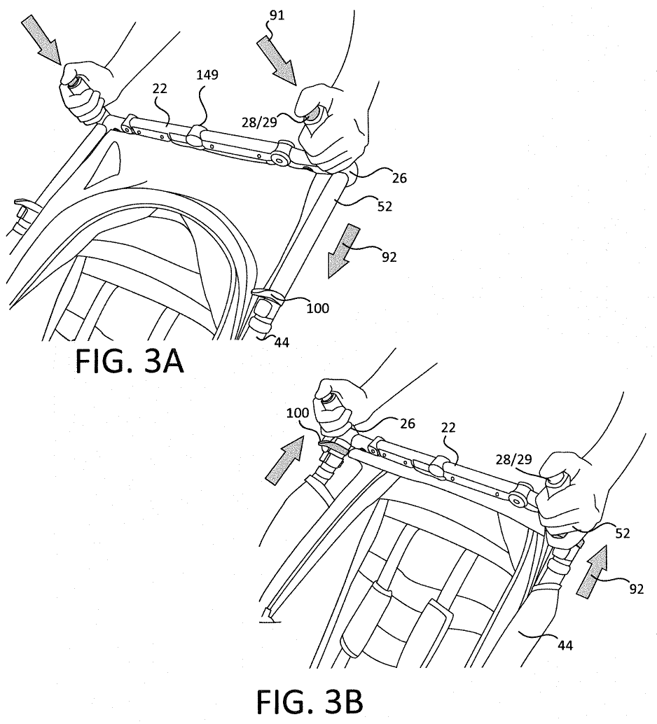

FIGS. 3A and 3B, illustrate how the user may engage the handle extension feature using the handle extension actuator 28. The user may engage the handle extension feature by depressing the handle extension actuator 28 with an external force 91. Applying the external force 91 disengages the handle extension locking mechanism 29 permitting an extension (FIG. 3B) or retraction (FIG. 3A) movement of the telescoping tubes 52. The user then applies an external force 92 to adjust telescoping tubes 52 upwardly or downwardly. The benefits of having the telescoping tubes 52 is to permit varying height options. For example, a taller user may find a full extension of the telescoping tubes 52 more comfortable than in a fully depressed configuration.

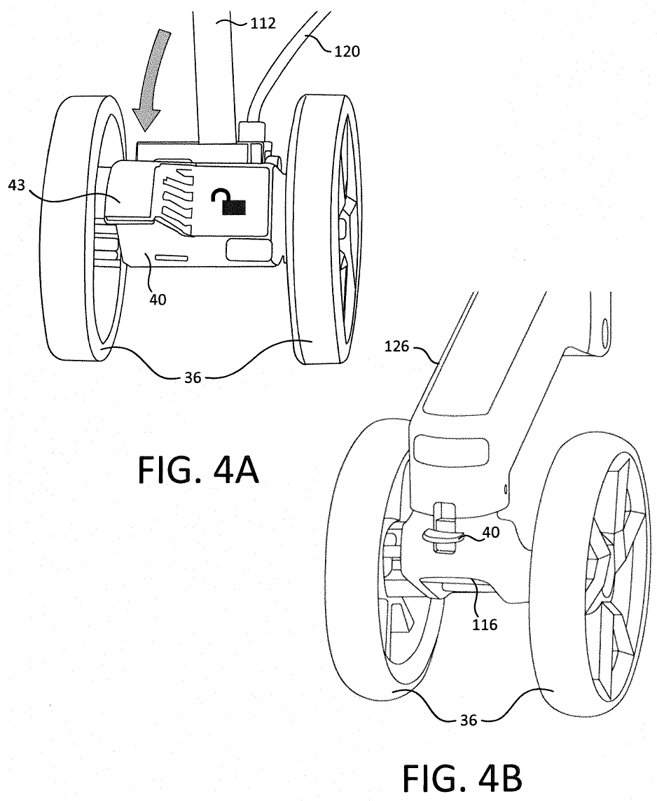

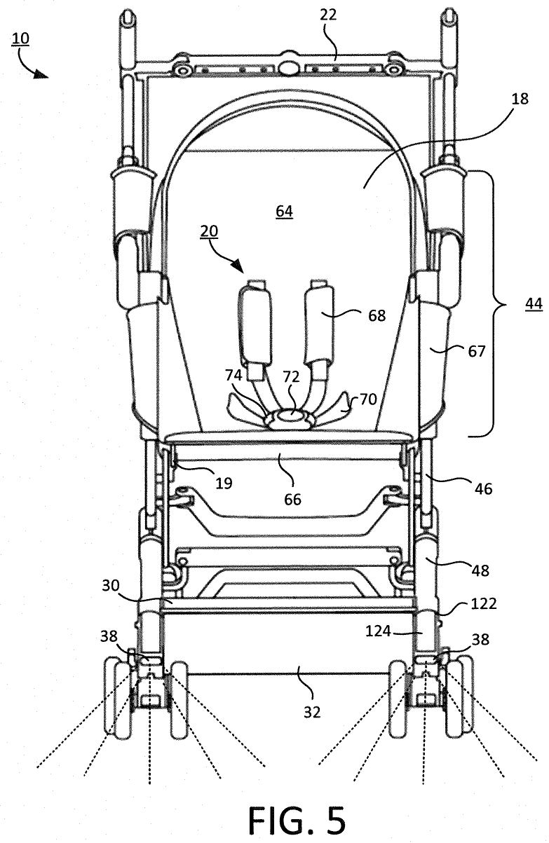

FIGS. 4A and 4B depict a wheel lock 40 attached to the wheels 36. The wheel lock 40 restricts the movement of the wheels 36 when engaged. The wheel lock 40 may be, but is not limited to, a lever that applies pressure to the wheels 36, a lever or push tab 43 that prevents rotational movement of the axle 116 or any other suitable locking mechanism capable of restricting the movement of the wheel 26 as described by the present subject disclosure. It is to be understood that the wheels 36 may have any combination of wheel lock 40. For example, the wheel lock 40 attached to the lower front segment 126 may be made of a push tab 43 (FIG. 4B), whereas the wheel 36 attached to the rear segment 112 may be made of a lever (FIG. 4A).

Further, as shown in FIG. 4A, the wheel lock 40 may also have a locking wire 120 that activates the wheel lock 40. The locking wire 120 is utilized to engage and disengage the wheel lock 40. The locking wire 120 may be engaged by pulling, pushing, or any other activation methods capable of engaging and disengaging the wheel lock 40. For example, the locking wire 120 may be connected between both wheel locks 40 attached to the rear segment 112 such that when on wheel lock 40 is engaged, the other wheel lock 40 is simultaneously engaged through the communication of the locking wire 120. The locking wire 120 may also be routed within the frame 12 such that is it not visibly seen from the exterior of the stroller 10.

The material of the frame 12 may be but is not limited to: aluminum, titanium, steal, plastic, or any suitable material capable of withstanding the weight of a child and conditions of the stroller 10 as described in this subject disclosure. Further, the frame 12 may be configured with a hollow or tubular construction to permit wiring, such as but not limited to the locking wire 120, to be routed therein.

FIG. 5 illustrates a footrest 30. The footrest 30 is located adjacent to the second connecting joint 122 of the upper front segment 124. The footrest 30 is fastened to the upper front segment 124 through one of many different fastening methods such as but not limited to: gluing, stapling, bolting, welding or any other suitable methods capable of securing the footrest 30 to the upper front segment 124. The footrest 30 sits below the seat 18, such that a child may rest their feet or legs on the footrest 30 when seated in the stroller 10. The material characteristic of the footrest 30 is, but not limited to, a rigid structure capable of withstanding the weight of a child who may utilize the footrest 30 to climb in and out of the seat 18. For example, the child may put their weight on the footrest 30 when climbing in and out of the seat 18. Various materials may be used, such as but not limited to: plastic, metal, taught fabric or any suitable material capable of withstanding the weight of a child.

FIGS. 5-8 illustrate the stroller 10 may also have a storage compartment 32 beneath the seat 18. The storage compartment 32 may be fastened to the lower frame member 48 through one of many different methods such as but limited to: gluing, bolting, riveting, strapping or any other suitable fastening method capable of securing the storage compartment 32 to the compact stroller 10. The storage compartment 32 may be made from fabric material. The storage compartment 32 is configured to store miscellaneous items such as but not limited to a diaper bag, blanket, toys, food or anything relating to traveling for use with the stroller 10 and child. It is to be understood that the storage compartment 32 may also be made of but not limited to: cloth, wool, fabric blend or any suitable material that can contain items as described in the subject disclosure.

The seat 18 that is removably secured to upper frame members 44 and midframe members 46. The seat 18 is formed by a seat backing 64, a seat base 66 and a lateral support 67. The seat base 66 is fastened to the seat support rails 19 (see FIG. 2) through one of many fastening methods such as but not limited to: hook and loop fastener, magnetic snaps, zipper, string ties or any other suitable fastening method capable of removably securing the seat base 66 to the seat support rails 19.

The seat 18 material may be but is not limited to: cloth, woold, polyester or any other suitable material capable of performing the features necessary to support a child as described in the present subject disclosure.

The lateral support 67 extends from the seat base 66 upwardly into the seat backing 64. The lateral support 67 is removably secured to the upper frame member 44. The lateral support 67 envelops the upper frame member 44 and is removably fastened by one of various fastening methods such as but not limited to: loop and hook strap, bolting, hook and loop fastener, magnetic snaps, zipper or any other suitable fastening method capable of removably securing the lateral support 67 to the upper frame member 44.

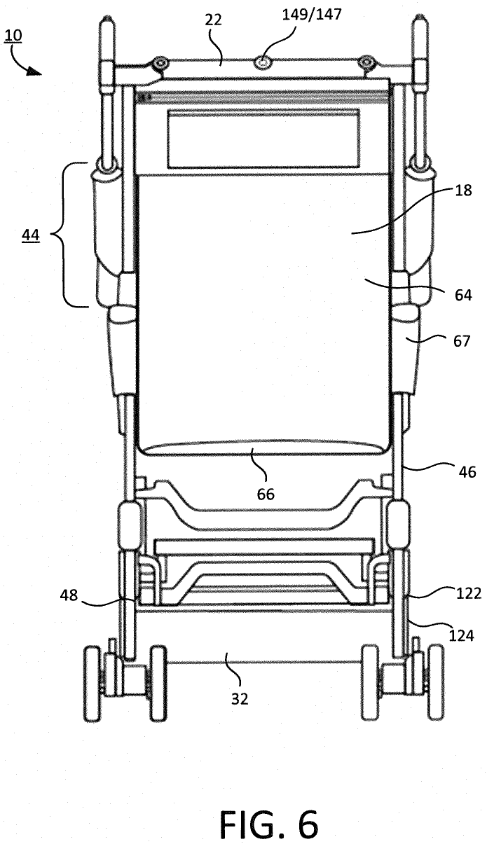

FIG. 6 depicts the seat backing 64 extending upward from the seat base 66 to the upper crossbar support 22 located at the upper frame members 44. The seat base 66 is securely fastened to the upper crossbar support 22, such that the seat backing 64 may support the weight of child resting against the seat backing 64.

Referring back to FIG. 5, incorporated into the seat backing 64 is a safety restraint mechanism 20. The safety restraint mechanism 20 is formed by a shoulder straps 68 and a torso strap 70 that securely connects to a crotch strap 72. The shoulder straps 68 are adjustable in length and can be movable secured vertically on the seat backing 64 to accommodate children of varying heights. The torso strap 70 is fixed to the seat backing 64 and also adjustable in length to accommodate children of varying sizes. The crotch strap 72 is movably secured to the seat base 66 to accommodate children of varying sizes. The shoulder strap 68, torso strap 70 and the crotch strap 72 all connect to a centrally located buckle 74 to securely fasten a child to the seat 18. The benefits of securing a child to the seat 18 is to prevent unwanted accidents such as when the child attempts to leave the seat 18 when in motion which may cause undesired harm. In alternative embodiments, the buckle 74 may substituted for but is not limited to: a magnetic clasp, magnetic buckle, tensioned hook fastener, rachet buckles, or any other suitable fastening method to securely engage the safety restrain mechanism 20.

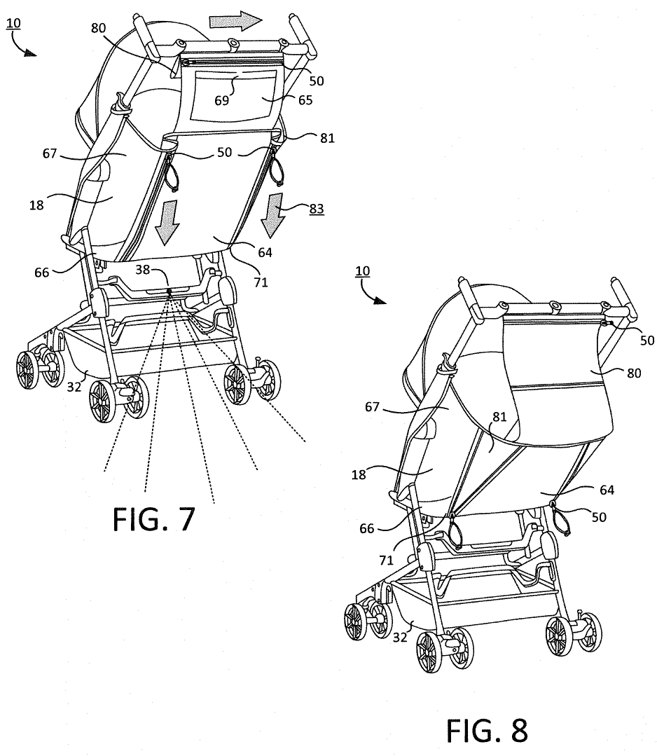

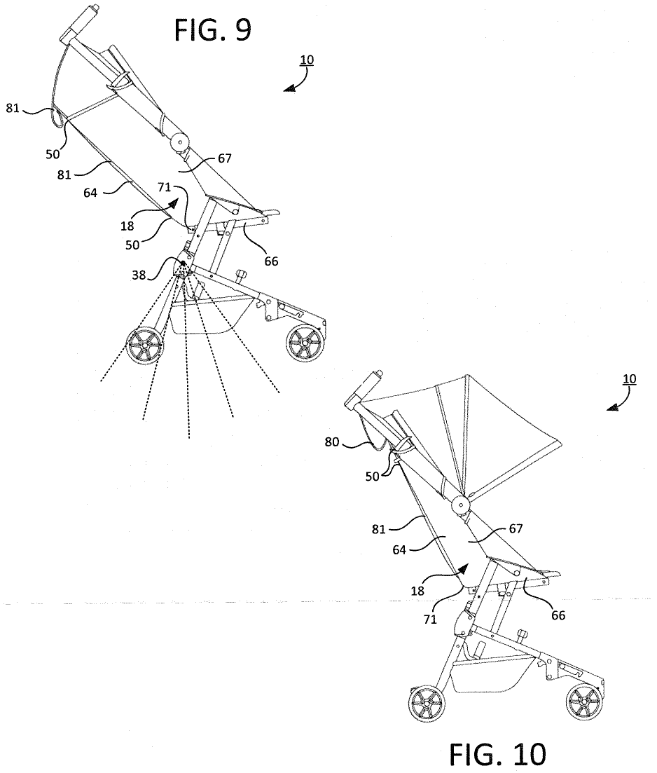

FIGS. 7-10 illustrate the seat backing 64 having a seat extension fabric 80. The lateral support 67 may have a lateral extension fabric 81, such that the seat 18 can be configured in an upright and reclined position. The seat extension fabric 80 and the lateral extension fabric 81 are configured to permit the seat 18 to be in a reclined position (FIGS. 8-9) when extended and permit the seat 18 to be in an upright position (FIGS. 7 and 10) when folded. As shown in FIGS. 7 and 10, when the seat extension fabric 80 and the lateral extension fabric 81 are folded into itself respectively, the seat 18 is configured to be in an upright position. Similarly, and shown in FIGS. 8-9, when the seat extension fabric 80 and the lateral extension fabric 81 are unfolded, the seat 18 effectively lowers into a reclined position.

FIGS. 7-10 show that when the seat extension fabric 80 and the lateral extension fabric 81 are respectively folded into themselves, a zipper 50 is utilized to keep the seat 18 in an upright position. When the user applies an external force 83 to undo the zipper 50 thereby securing the seat extension fabric 80 and the lateral extension fabric 81 together, the seat extension fabric 80 and the lateral extension fabric 81 may extend outwardly to reline the seat 18. It is to be understood that the zipper 50 may be substituted for an alternative fastener such as but not limited to: hook and loop fastener, magnetic clasp, button clasps or any other suitable fastening method capable of retaining the folded seat extension fabric 80 and the folded lateral extension fabric 81 as described in the present subject disclosure. The seat extension fabric 80 and the lateral extension fabric 81 may be configured to varying lengths to permit different recline angles for the seat 18. Further, it is to be understood that the seat 18 may be adjusted to recline through alternative methods such as, but not limited to, a hinge point 71 located at the seat base 66 such that the seat 18 may pivot about the hinge point 71 to provide varying degrees of rotation and recline angles.

FIG. 7 illustrates the seat backing 64 may have a storage compartment 65. The storage compartment 65 may be a sewn-on piece of fabric with a storage fastener 69. The storage compartment 65 may be located on the upper section of the seat backing 64 but it is to be understood that the storage compartment 65 may be located at any point on the seat backing 64. The storage compartment 65 may be configured to store miscellaneous items such as but not limited to a phone, a water bottle, a pacifier, a wallet or any other items suitable when in transit with the stroller 10. The storage fastener 69 may be but is not limited to: a zipper, hook and loop fastener, magnetic clasp or any other suitable fastening method capable of securing items within the storage compartment 65.

As shown in FIGS. 7 and 9, an illumination source 38 may be provided anywhere on the stroller to provide a source of light into, or in an environment surrounding the stroller 10. In FIG. 7, the illumination source 38 is directed backward onto the ground, as well as into the lower storage compartment of the stroller 10. In FIG. 9, the illumination source 38 is directed sideways so that the user can illuminate the surrounding ground in an area to the side of the stroller 10.

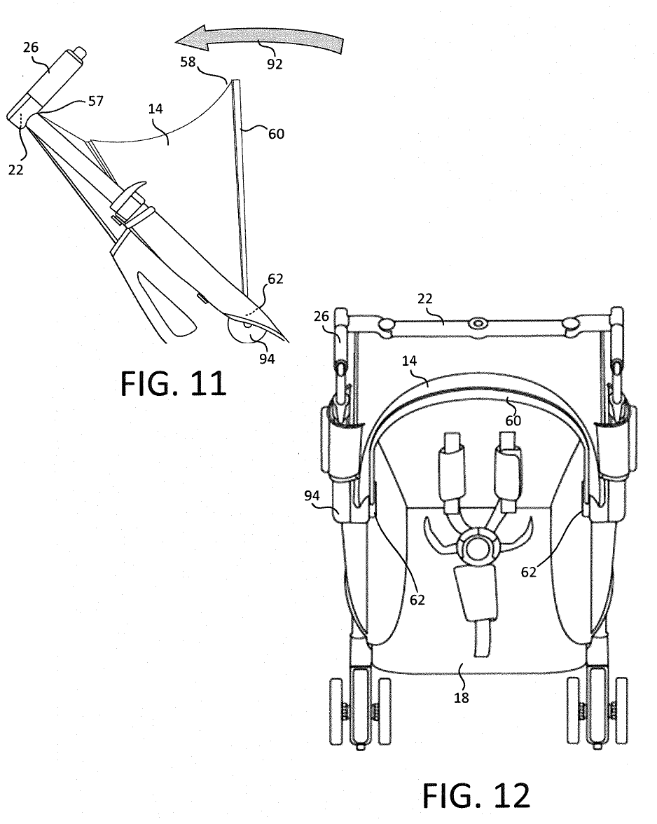

FIGS. 11-15 depict the stroller 10 having a canopy 14 that sits atop the seat 18. The canopy 14 is made from stretchable fabric such as but not limited to: cloth, polyester or any other suitable material capable of flexion as described in the present subject disclosure. The material characteristics of the canopy 14 permit the canopy 14 to be breathable, stretchable and UV ray resistant. As shown in FIG. 11 the canopy 14 may be fastened to the upper crossbar 22 at one end 57 and connected to a canopy brim 60 at a second end 58. The canopy brim 60 is pivotally connected to a canopy pivot joint 62. The canopy brim 60 may be formed by a rigid member sewn into the second end. The rigid member is bent to form a parabolic structure that is pivotally connected at its ends to the canopy pivot joints 62. The canopy pivot joint 62 is secured to the member joint 94, such that the canopy 14 may independently rotate about the canopy pivot joint 62 from the member joint 94.

The canopy 14 may provide shade coverage over the seat 18 when the canopy 14 is fully extended over the seat 18. The canopy 14 may further have a canopy extension 84 that is configured to extend the length of the canopy 14. The canopy extension 84 may be of the same material as the canopy 14 or it may comprise of an alternative material. In alternative embodiments the canopy extension 84 may be made of but not limited to: a mesh screen, a see-through plastic, or any other suitable material capable of extending the canopy 14 as described by the present subject disclosure. The benefit of the canopy extension 84 having an alternative material from the canopy 14 may permit the user of the stroller 10 to peer through the canopy extension 84 to see the occupant sitting in the seat 18. For example, if the canopy extension 84 was made of a see-through mesh material, a parent may look through the canopy extension 84 to visibly see their child in the seat 18.

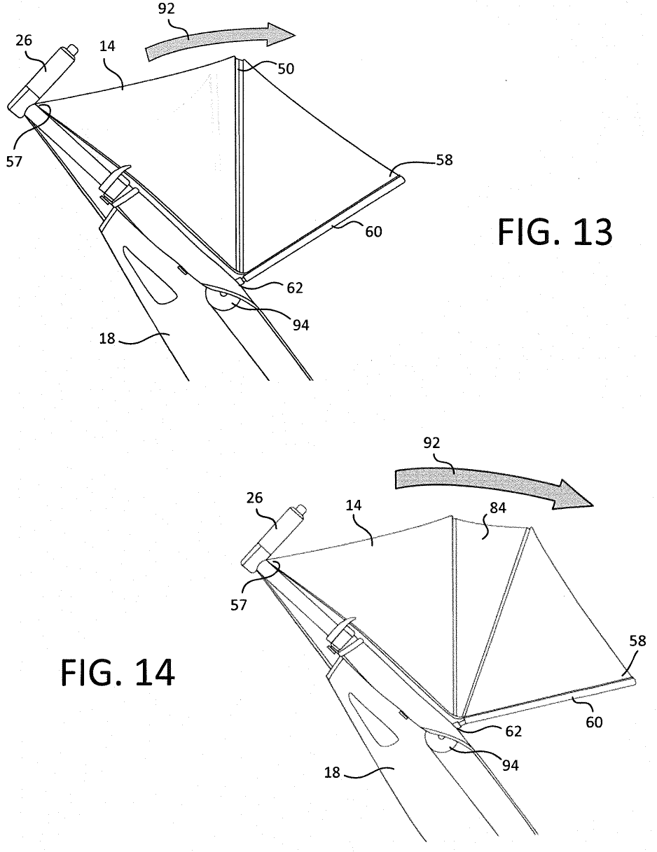

FIG. 13 illustrates when the canopy extension 84 is folded into itself and is fastened by a zipper 50, the canopy extension 84 is in the retracted position. It is to be understood that the canopy extension 84 may be fastened together through one of many alternative methods. Such fastening methods may consist of but are not limited to: magnetic clasps, a second canopy brim permitting a second pivot point for the canopy extension 84, a hook and loop fastener or any other suitable method to fasten the folded canopy extension 84 together as described in the present subject disclosure.

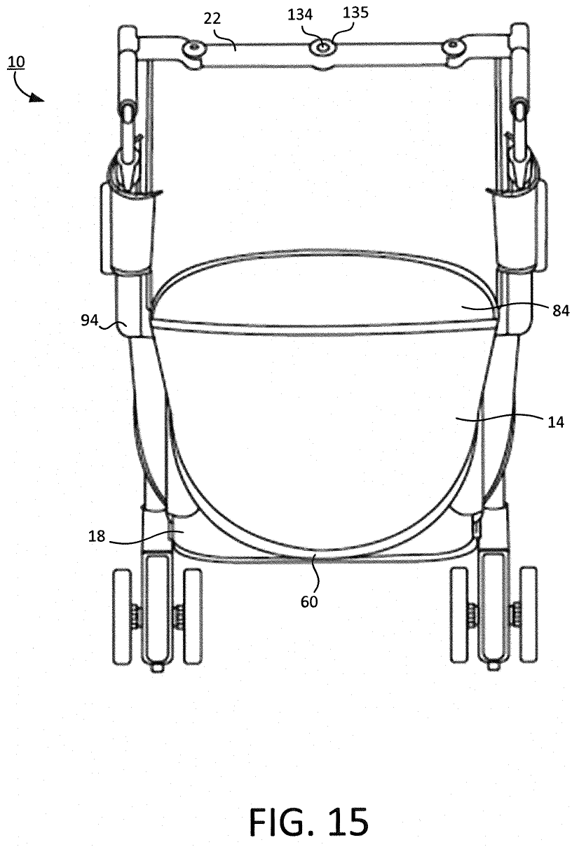

The canopy 14 is capable of a fully retracted configuration, a partial extended configuration and a fully extended configuration. As shown in FIGS. 11-12, when a user applies an external force 92 to the canopy 14 inward towards the handle 26, the canopy 14 will be fully retracted and shown in FIG. 12. When the canopy 14 is in the fully retracted configuration A, the seat 18 and the seat 18 occupants are fully exposed to the atmosphere as shown in FIG. 12. As shown in FIG. 13, when a user applies the external force 92 to the canopy 14 away from the handle 26, the canopy 14 is extended into the partial extended configuration. As shown in FIG. 14-15, when the user unfastens the canopy extension 84, and applies the external force 92 outwardly away from the handle 26, the canopy 14 is fully extended into the fully extended configuration. When the canopy 14 is in the partial extended configuration or the fully extended configuration, the seat 18 and the seat 18 occupants are covered from to the atmosphere as shown in FIG. 15.

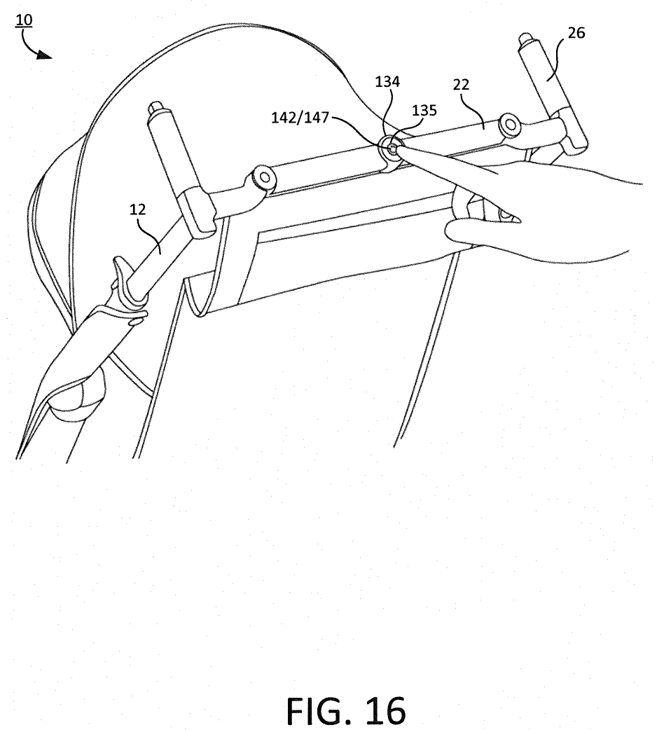

FIG. 16 illustrates a power button 134 adapted to illuminate an illumination source 38 such as shown in FIG. 1. The power button 134 is integrated into upper crossbar support 22. The power button 134 may be located at the midpoint of the upper crossbar support 22 and may be raised slightly outward from the upper crossbar support 22. The power button 134 may be, but is not limited to, circular in shape. It is to be understood that the power button 134 may also be flush with the upper crossbar support 22. Further, it is to be understood that the power button 134 may be located anywhere throughout the frame 12 of the stroller 10. For example, the power button 134 may be located on the handle 26. The power button 134 may be but is not limited to: a button, switch, touch sensor or any other suitable method of controlling a power source 158. The benefits of having the power button 134 on the upper crossbar support 22 is to provide ease of access for a user pushing the stroller 10. For example, the user may continually push the stroller 10 in a forward motion and simultaneously press the power button 134. The power button 134 may also have alternative shading or color for ease of visibility. For example, the power button 134 may be colored white when the upper crossbar support 22 is colored black. Further, the power button 134 may also have a power indicator 135 encircling the power button 134. The power indicator 135 may have a light source that illuminates when the power source is turned on or it may serve as a communication signal to the stroller 10 user as will be discussed later in this disclosure.

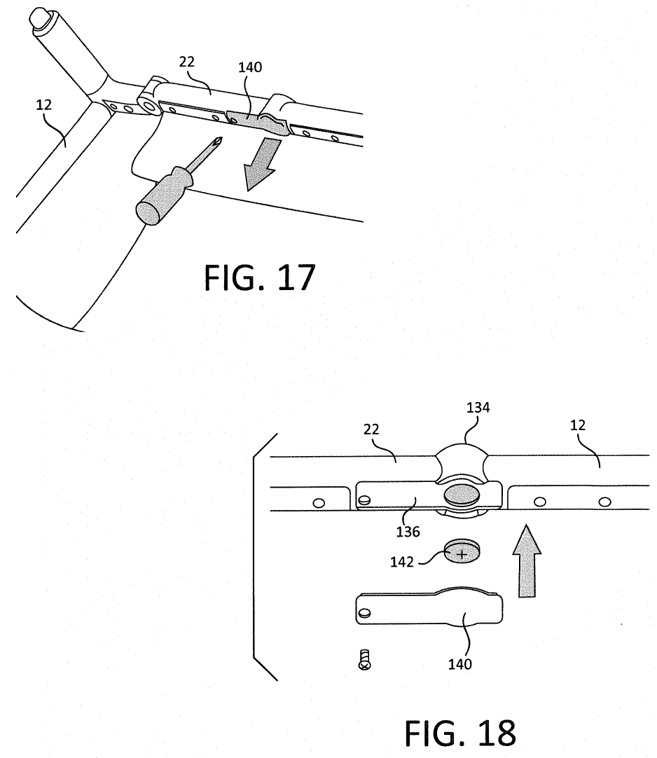

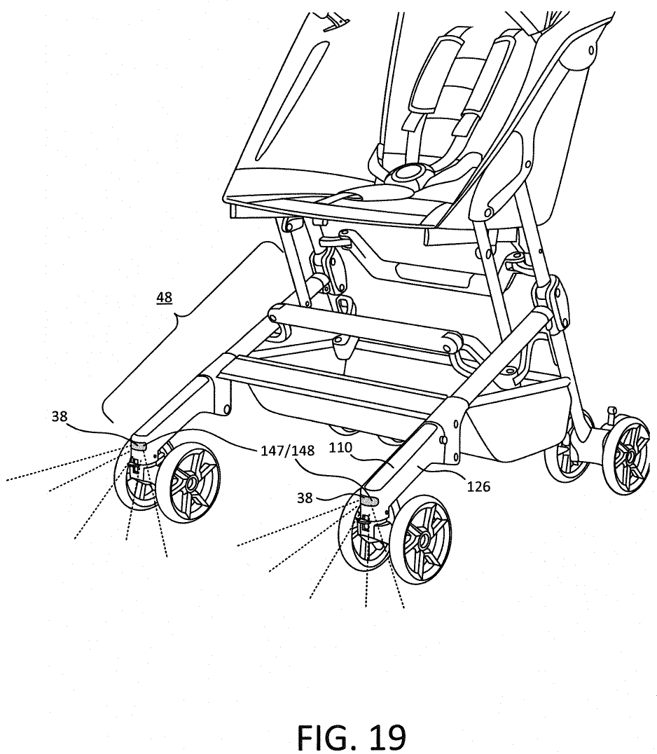

FIGS. 17-18 depict a power button compartment 136 that is located on the underside of the upper crossbar support 22, directly behind the power button 134. It is to be understood that the power button compartment 136 may be located anywhere about the frame 12. The power button compartment 136 is enclosed by a power button face plate 140. The power button face plate 140 is removably secured to the power button compartment 136 through one of many fastening methods such as but not limited to: screws, magnetic clasps, press fit or any other suitable fastening methods capable of removably securing the power button face plate 140 to the power button compartment 136. Located within the power button compartment 136 is a power source 142. The power source 142 may be but is not limited to a battery or any other suitable method of capacitance capable of supplying power to the power button 134 as described in this subject disclosure. Alternatively, the illumination source 38 may be provided by a self-generating power source 142. For example, the wheels 36 may be equipped with magnets inside a coil that could induce enough electricity to be stored and to run the illumination source 38. Further, the power button compartment 136 may also house additional electronic members such as but not limited to a circuit board, transmitter, receiver or any other electronic devices capable performing the functions as described in this subject disclosure. The power button 134 that is configured to turn on/off the power source 142 for the illumination source 38 as shown in FIG. 19.

FIG. 19 illustrates the illumination source 38 integrated into the lower front segment 126 of the front segment 110. The illumination source 38 is located at the distal end of the lower front segment 126. The illumination source 38 is configured to provide a light in low lit environments. The lower front segment 126 is configured to act as a lower housing 144 for the illumination source 38 and accompanying electronics system 148 as will be discussed in greater detail later in this subject disclosure.

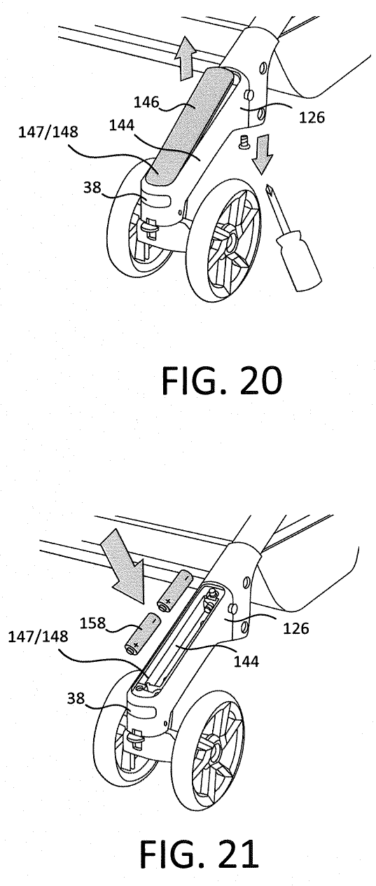

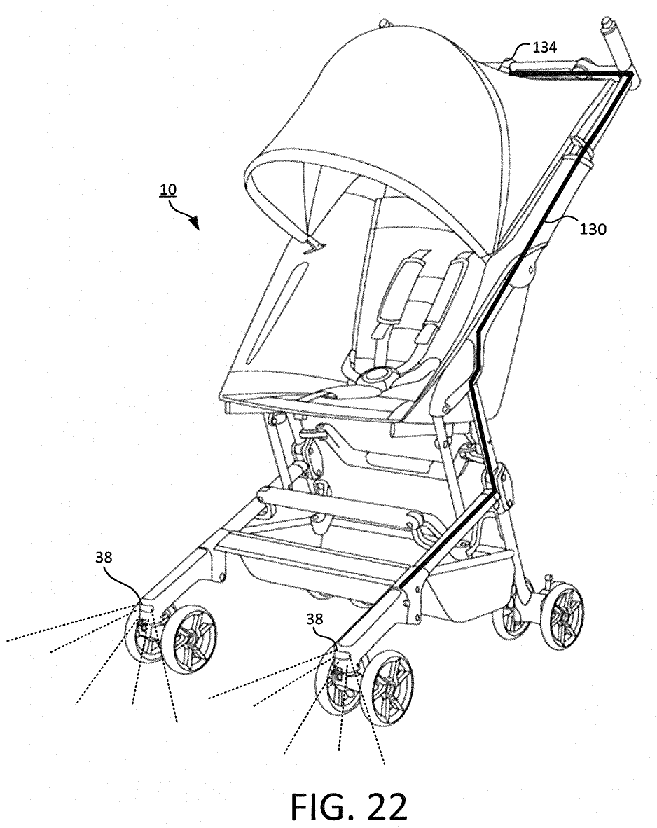

FIG. 20-21 illustrate the lower front segment 126 having a lower face plate 146 to provide access to the illumination source 38 and accompanying electronics system 148 (not shown) within the lower housing 144. The lower face plate 146 may be removably secured to the lower housing 144 by one of many different fastening methods such as but not limited to: screws, magnetic closure, press fit closure or any other suitable method for removably securing the lower face plate 146 to the lower housing 144.

FIG. 22 shows the power button 134 in communication with the illumination sources 38 through an integrated wiring system 130. When the user presses the power button 134, a signal is sent to the illumination source 38 through the integrated wiring system 130 to turn on/off. The integrated wiring system 130 may be enclosed by the frame 12. The benefits of having the integrated wiring system 130 enclosed by the frame 12 is to visibly conceal the integrated wiring system 130 from a user and further prevent exposure from the atmosphere. It is to be understood that the communication between the power button 134 and the illumination source 138 may also be wireless. The wireless communication may be, but is not limited to: Bluetooth, Wi-Fi, radio broadcasting, infrared, satellite, microwave or any other suitable method capable of providing wireless communications.

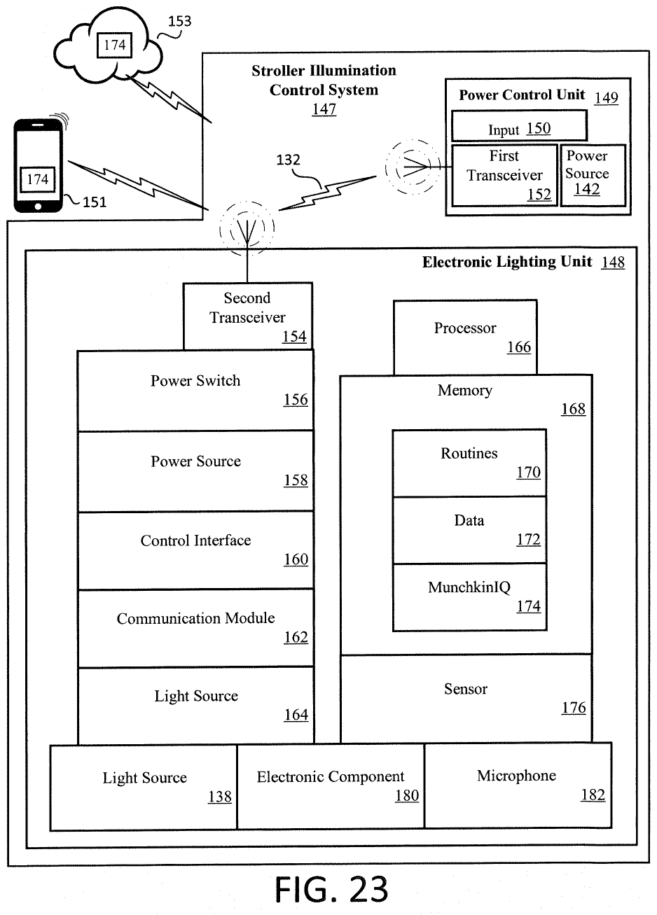

FIG. 23 depicts an exemplary stroller illumination control system 147 including a power control unit 149 in communication with an electronic lighting unit 148. As will be described in more detail below, the power control unit 149 controls power to the electronic lighting unit 148.

The power control unit 149 of the stroller 10 may be configured with various electronic components to permit wired or wireless communication with the electronic lighting unit 148. Further, the various electronic device components of the power control unit 149 and the electronic lighting unit 148 are embedded within the stroller 10 to allow the stroller 10 to be compact and modular.

The power control unit 149 of the stroller 10 includes a power source 142, an input 150 and a first transceiver 152. The input 150 may be connected to the first transceiver 152, and although shown as a button, the input 150 may be embodied as a digital interface capable of displacing information to send or receive data to or from the electronic lighting unit 148. The first transceiver 152 transmits an electronic signal 132 to a second transceiver 154 to perform a desired action. The first transceiver 152 and the second transceiver 154 electronically communicate back and forth to transmit and receive signals therebetween. The first transceiver 152 and the second transceiver 154 may alternatively communicate with an externally or remotely located application, hereafter referred to as MunchkinIQ 174 that can send and receive commands such as with a smart device 151. The MunchkinIQ 174 application may be located remote in an iOT cloud server 153, on a smart device 15, such as a mobile phone and/or any other suitable device capable of communicating with the stroller illumination control system 147. The MunchkinIQ 174 application located within the iOT cloud server 153 and/or the smart device 151 may communicate directly with the stroller illumination control system 147.

If a sensor 176 detects a condition requiring a response by the input 150 adjacent to the user, the sensor 176 may generate a signal that is transmitted back to the input 150, to alert the user, or to require an additional action by the user. For example, if a pothole or curb in front of the stroller 10 is detected, a signal back from the sensor 176 can warn and inform the user at the input 150 interface of the imminent curb or pothole. For example, the input 150 may be the power button 134 that is connected to the first transmitter 152, located in the power button housing 138. In this instance, the first transceiver 152 can communicate with the second transceiver 154 located in the lower housing 144 to turn on the illumination source 38.

The second transceiver 154 can send and receive various electronic signals 132 to and from a processor 166. The processor 166 is connected to a memory 168. The memory 168 is capable of storing various routines 170, collect/utilize data 172 and further integrate cloud communication via MunchkinIQ 174.

The processor 166 takes the electronic signal 132 and in conjunction with the memory 168 executes a routine 170 or stored function. For example, a stored routine may be a timing sequence routine wherein after the electronic signal 132 is received and processed, a duration timer for the illumination source 38 begins that can limit the duration the illumination source 38 may be turned on with or without secondary input 150 from the user, such as pressing the power button 134 for a predetermined period of time, such as every 15 mins.

The electronic lighting unit 148 may further include a sensor 176 that receives an input 150 that is external allowing an autonomous routine to be executed. For example, the external input 150 may come from a photocell located on the exterior of the frame 12, where the photocell sends the electronic signal 132 to the sensor 176 that relays the electronic signal 132 to the processor 166 to turn on the light source 178. The benefits of having autonomous functions through an external input 150 is that it allows the user to keep focus on their child sitting in in the stroller 10 while the stroller illumination control system 147 monitors the environment and can autonomously operate features, such as the illumination source 38. It is to be understood that the sensor 176 may be, but is not limited to: a photocell, proximity sensor, wireless sensor network, capacitive sensor, accelerometer, or any other suitable sensor capable of providing an electronic signal 132 to and from the processor 166. For example, if the stroller 10 is outfitted with a capacitive sensor to gauge when the power source 158 is running low, a communication signal 132 can be generated to alert the user through an application, such as the MunchkinIQ 174 to alert the user to change or recharge the power source 158.

Further, the electronic lighting unit 148 may include but is not limited to: a power switch 156, a power source 158, a communication module 162, a light source 164, an electronic component 180, a microphone 182 or any other suitable electronic device capable of performing the features as described in the present disclosure.

The power switch 156 is utilized to turn on the power source 158. The power switch 156 may be turned on manually by the user from an external button on the outside of the lower housing 144. Alternatively, the power switch 156 may be turned on through an electronic signal 132. It is to be understood that the power switch 156 controls the flow of electricity from the power source 158 to the electronic lighting unit 148 and related components. Further, it is to be understood that the electronic lighting unit 148 may have capacitance such that it may operate when the power switch 156 is turn off, allowing the electronics system 148 to receive and execute commands.

The power source 158 may be, but is not limited to: batteries, rechargeable battery packs, solar regenerative battery packs in communication with a solar panel on the exterior of the frame 12 or any other power source capable of capacitance to supply power to the stroller 10 as described in this subject disclosure, and as shown in FIG. 21.

Referring back to FIG. 23, the control interface 160 permits the user to designate which modular features will be engaged when the stroller 10 is turned on. For example, the MunchkinIQ 174 permits cloud 153 communication with an accompanying wireless MunchkinIQ 174 application such that a user may configure routines 170, control the data 172 or adapt various modular components, such as the light source 164, to the stroller 10.

The communication module 162 permits the stroller 10 to integrate with an electronic component 180 to provide two-way communication between the user and the electronic component 180. For example, if the stroller 10 is configured with a speaker and microphone component, the microphone 182 would be capable of receiving the verbal communication from a user and process the necessary function to transmit the communication through the communication module 162.

The light source 164 may serve as a visual indicator for when the power source 158 is turned on and/or to indicate that there was some sort of an error. For example, if the power source 158 is too low to supply power to the electronic component 180, the light source 164 may blink red to alert the user. Further, the second transceiver 154 may communicate back to the first transceiver 152 to communicate with the user through the input 150. For example, if the illumination source 38 has been on for greater than 30 mins, a routine 170 may execute to send a signal to the power indicator 135 to blink until pressed to leave the illumination source 38 on.

The light source 138 may be schematically configured in the electronic lighting unit 148 as the illumination source 38 as described in this subject disclosure previously. Moreover, the stroller 10 may also be configured with multiple illumination modular components throughout the stroller 10 that are connected to the electronic lighting unit 148. For example, the light source 138 may be configured to be on upper crossbar support 22, mid-crossbar support 24, and/or lower crossbar support 25 to provide light all around the stroller 10 in low lit environments. The light source 138 may be directed to provide light in any direction desired.

The stroller 10 may also be configured with a microphone 182 connected to the electronic lighting unit 148 capable of detecting noise within the seat 18 when a child is seated. For example, if a child is sleeping in the seat 18, the parent of the child may utilize the microphone 182 as an active listening device to know when the child awakes.

The electronic lighting unit 148 permits the stroller 10 to have a power source 158 capable of being configured with various modular electronic components 180 such as but not limited to: a camera, phone charger, bottle warmer, fan, monitor, a motion sensor, a temperature sensor, and/or any other electronic device capable of monitoring the passenger or the environment surrounding the stroller 10. It is to be understood that the electronic components 180 are modular such that they may be interchanged with other electronic components 180. For example, the electronic component 180 can be a phone charger located on the upper crossbar support 22 that can be interchanged with an adaptable bottle warmer. The stroller 10 permits interchangeable electronic components 180 since the frame 12 may be configured to have the power source supply electricity throughout the frame 12 through the integrated wiring 130.

The frame 12 may also be configured with mounting brackets to permit interchangeability with alternative modular electronic components 180. For example, a mounting bracket may be placed on the upper crossbar support 22 that can receive a mating bracket on one of many alternative electronic components 180. It is to be understood that the mounting brackets may be placed anywhere along the frame 12. Further, the mounting bracket may include, but is not limited to: a magnetic fastener, press or snap fit fastener and/or any other suitable fastening method capable of removably securing the electronic component 180 to the frame 12.

FIGS. 1-2 and 24-28 demonstrate the stroller 10 may be configured to pivotally fold into itself for ease of storage. The upper crossbar support 22, mid-crossbar support 24 and lower crossbar support 25 may be connected through a combination of a plurality of pivot joints 54, the member joint 94, the connecting joint 114, and the second connecting joint 122 are engaged/disengaged through internal joint locks 102. The plurality of pivot joints 54, the member joint 94, the connecting joint 114, and the second connecting joint 122 respectively define pivot points.

In particular, FIGS. 24-28 illustrates a user applying a downward rotational force 186 to the stroller 10 after the user disengaged the internal joint locks 102 by actuating the folding actuator 100. The stroller 10 then collapses and folds at each of the plurality of pivoting points into a semi-folded configuration as shown in FIG. 26.

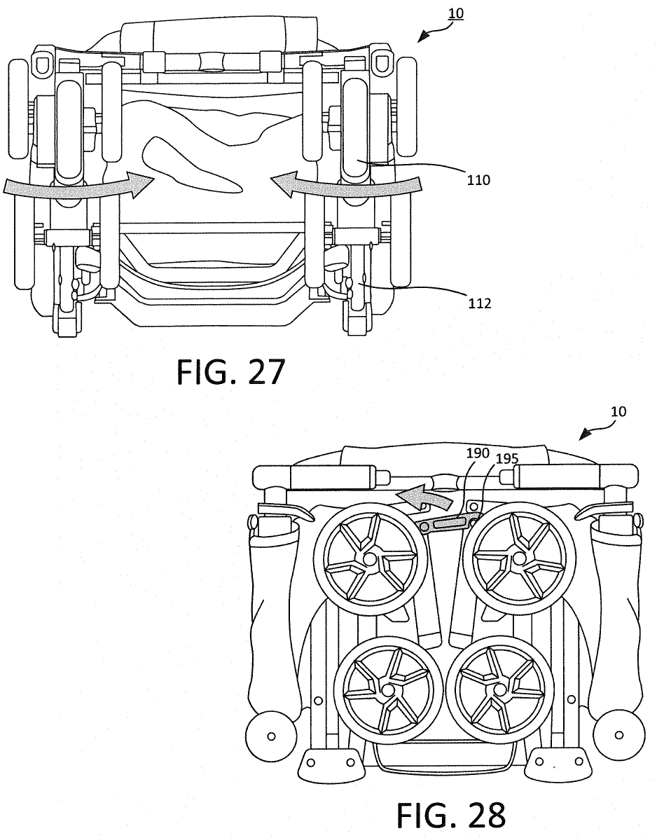

The user then applies a squeezing force 188 to the rear segment 112 and to the upper frame members 44 which disengages the internal joint lock 102. The internal joint lock 102 then disengages the front segment 110, folding at the second connecting joint 122 towards the rear segment 112 forming a compact folded configuration as shown in FIG. 27. From the semi-folded configuration, the user then pushes the folded front segment 110 and folded rear segment 112 inward to form a fully folded compact configuration as shown in FIG. 28. The user then may rotate a folding lock 190, located on the front segment 110, onto a mating protrusion 195, whereby the fully folded compact configuration is maintained. The user then may unfold the stroller 10 taking steps in the reverse order as described above.

In the fully folded compact configuration, the stroller 10 may fold down to fit within a length of 15 inches, a width of 14 inches and a height of 6.25 inches. Alternatively, in the fully folded compact configuration, the stroller 10 may fold down to fit within a length of 22 inches, a width 14 inches, and a height 9 inches. It is to be understood that in the fully folded compact configuration, various other similar configuration may be selected.

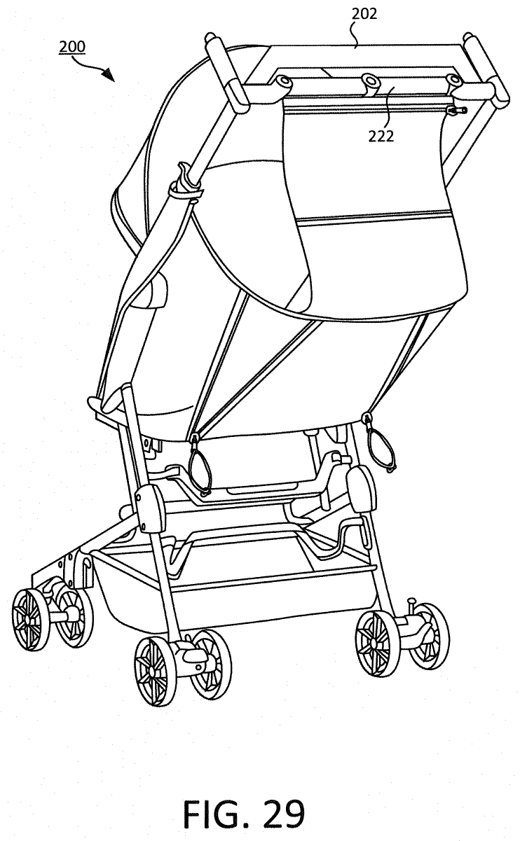

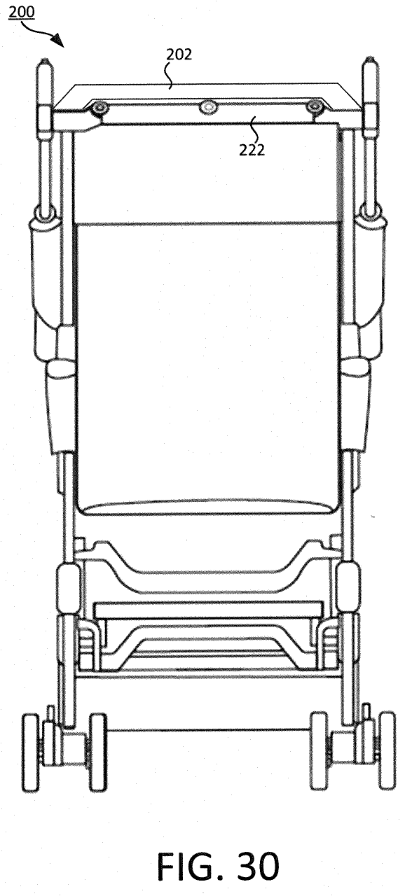

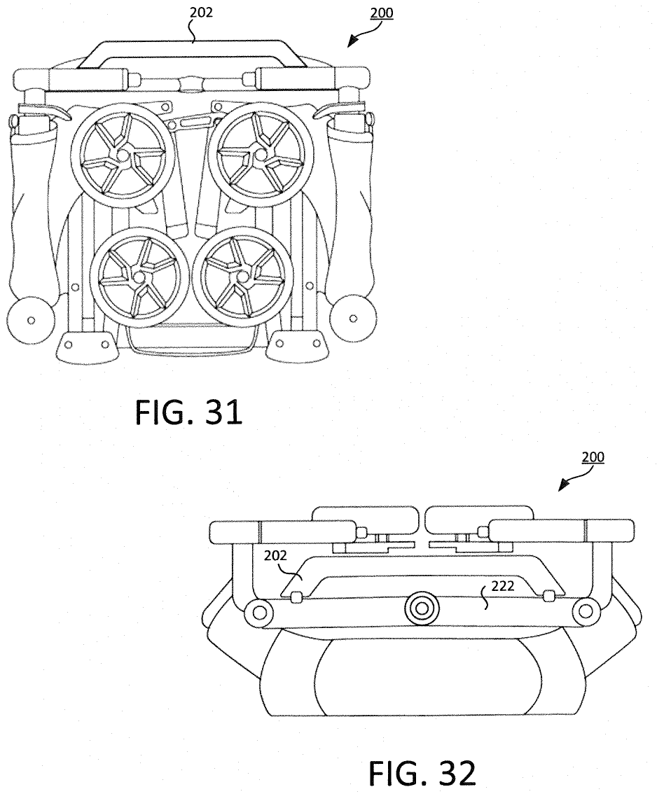

FIGS. 29-32 show an alternative embodiment of a stroller 200. The stroller 200 has a secondary handle 202. The secondary handle 202 may be pivotally attached to an upper crossbar support 222. The secondary handle 202 promotes ergonomic hand grips to permit the user to rest their hands in a fully and/or semi supinated and/or pronated hand position. The secondary handle 202 may be utilized as a carrying handle when the stroller 200 is in a folded configuration such as shown in FIG. 31. Alternatively, the secondary handle 202 may be pivotally folded inward to sit within the space between a handle 226 and the crossbar support 220 such as shown in FIG. 32.

The illustrations and examples provided herein are for explanatory purposes and are not intended to limit the scope of the appended claims. It will be recognized by those skilled in the art that changes, or modifications may be made to the above-described embodiments without departing from the broad inventive concepts of the invention. It is understood therefore that the invention is not limited to the embodiments which are described but is intended to cover all modifications and changes within the scope and spirit of the subject disclosure.

The foregoing disclosure of the exemplary embodiments of the present subject disclosure has been presented for purposes of illustration and description. It is not intended to be exhaustive or to limit the subject disclosure to the precise forms disclosed. Many variations and modifications of the embodiments described herein will be apparent to one of ordinary skill in the art in light of the above disclosure. The scope of the subject disclosure is to be defined only by the claims appended hereto, and by their equivalents.

Further, in describing representative embodiments of the present subject disclosure, the specification may have presented the method and/or process of the present subject disclosure as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present subject disclosure should not be limited to the performance of their steps in the order written, and one skilled in the art can readily appreciate that the sequences may be varied and still remain within the spirit and scope of the present subject disclosure.

What is claimed is:

1. A stroller, comprising:
a frame having a plurality of legs extending from a lower portion of the frame with a plurality of wheels attached thereto;
a seat supported by the frame; and
an illumination source incorporated within a body of the frame that illuminates an area in or around the stroller.

2. The stroller recited in claim 1, wherein the illumination source is electrically connected within an illumination control system that is adapted to detect a condition to turn the illumination source on or off.

3. The stroller recited in claim 2, wherein the illumination control system is adapted to wirelessly communicate with a smart device, in which the illumination control system is adapted to receive a control signal from the smart device to turn the illumination source on or off.

4. The stroller recited in claim 2, wherein the illumination control system has an input source adapted to activate the illumination source.

5. The stroller recited in claim 1, wherein the illumination source is connected to an input source adapted to activate the illumination source wirelessly.

6. The stroller recited in claim 5, wherein the input source is located adjacent to an upper end of the frame.

7. The stroller recited in claim 1, wherein the illumination source is located within the body of the frame adjacent to a lower end of the frame.

8. A stroller, comprising:
a frame with a handle disposed at an upper portion, the frame having a plurality of legs extending from a lower portion with a plurality of wheels attached thereto;
a seat supported by the frame; and
an input source connected to an illumination source, both the input source and the illumination source are incorporated within a body of the frame, wherein the illumination source is adapted to illuminate an area in or around the stroller.

9. The stroller recited in claim 8, wherein the illumination source and the input source are part of an illumination control system adapted to detect a condition to turn the illumination source on or off.

10. The stroller recited in claim 8, wherein the input source is provided in the upper portion of the frame and is electrically connected to activate the illumination source.

11. The stroller recited in claim 8, wherein the input source is wirelessly connected to activate the illumination source.

12. The stroller of claim 8, wherein the input source is disposed adjacent to the handle at an upper portion of the frame, and the illumination source is disposed adjacent to the lower portion of the frame.

13. The stroller of claim 8, wherein the input source is disposed adjacent to the handle at an upper portion of the frame, and the illumination source is disposed within at least one of the plurality of legs.

14. A foldable stroller, comprising:
a collapsible frame;
a seat overlaying the collapsible frame having a safety restraint mechanism incorporated into the seat;
a plurality of legs extending from a lower portion of the collapsible frame having fixed to each end a wheel;
an upper cross bar and a lower cross bar interposed within the collapsible frame; and
an illumination control system having an illumination source incorporated within the body of the collapsible frame, the illumination control system detecting a condition to turn the illumination source on or off in an area in or around the stroller.

15. The foldable stroller recited in claim 14, wherein the illumination control system has an input source adapted to activate the illumination source.

16. The foldable stroller recited in claim 14, wherein the illumination control system has an input source adapted to activate the illumination source wirelessly.

17. The foldable stroller of claim 14, wherein the input source is disposed in a power control unit disposed adjacent to the upper cross bar, and the illumination source is disposed in an electronic lighting unit disposed adjacent to the lower cross bar.

18. The foldable stroller of claim 14, wherein the input source is disposed in a power control unit disposed within the upper cross bar, and the illumination source is disposed in an electronic lighting unit disposed within at least one of the plurality of legs.

19. The foldable stroller recited in claim 14, wherein the illumination control system is adapted to wirelessly communicate with a smart device, in which the illumination control system is adapted to receive a control signal from the smart device to turn the illumination source on or off.

20. The foldable stroller of claim 14, wherein the upper cross bar is configured as a handle to carry the foldable stroller when in a compact collapsed storage position.
